(19) United States
(12) Patent Application Publication
(10) Pub. No.: US 2006/0026107 A1
(43) Pub. Date: Feb. 2, 2006

(54) Mechanisms for waiving or reducing senders' liability in bonded electronic message systems while preserving the deterrent effect of bonds

(76) Inventor: Frank Urro, Billerica, MA (US)

Correspondence Address: Gregory P. Gadson, Esq., 19375 Amber Way, Noblesville, IN, 46060, US

(21) Appl. No.: 10/902,748

(22) Filed: Jul. 29, 2004

(51) Int. Cl. H04L 9/00

(52) U.S. Cl. 705/65

(57) ABSTRACT

A novel method of regulating electronic communications at least includes receiving an electronic communication from a sender for an intended recipient, determining whether the electronic communication is accompanied by a sufficient satisfaction bond, forwarding the electronic communication to the intended recipient when the electronic communication is accompanied by a sufficient satisfaction bond, determining whether a sufficient trust relationship exists between the sender and the intended recipient when the electronic communication is not accompanied by a sufficient satisfaction bond, and forwarding or refraining from forwarding the electronic communication to the intended recipient depending on whether a sufficient trust relationship exists between the sender and the intended recipient.

### BACKGROUND OF THE INVENTION

1. Field of the Invention

The present invention generally relates to methods for reducing unwanted electronic communications, with a non-limited emphasis upon “spam” and other forms of unwanted electronic mail. More particularly, the present invention relates to modifications to systems for reducing unwanted electronic communications with greater flexibility than pure bonded communication approaches.

2. Background

The proliferation of unwanted electronic communication such as unwanted electronic mail (“e-mail”), which is sometimes termed “spam,” is a continuing source of annoyance and productivity loss for many communication customers, including Internet and telephone customers. One promising approach for reducing spam and other unwanted electronic communication is described in U.S. Pat. No. 6,697,462, assigned to Vanquish, Inc., also the assignee of the present application.

U.S. Pat. No. 6,697,462 allows a recipient or prospective recipient of electronic communications to require that senders of these messages post a satisfaction bond along with, or prior to sending the electronic communication. Further, (with knowledge to the sender) the bond is forfeited if the recipient rejects the communication upon receiving it or considering it. This is summarized in the aforementioned letters patent in the following manner:
[T]he present invention provides a method of regulating electronic communications. The method at least includes the steps of receiving a communication from a sender for a designated recipient, comparing sender identity indicia attached to the communication with stored sender identity indicia in a database under the control of the recipient, and presenting the communication to the recipient for acceptance or rejection, when the sender identity indicia is determined to be acceptable. The method further at least includes the steps of sending a return message to the sender indicating that a bond must be posted when the sender identity indicia is not determined to be acceptable, and that money associated with the bond shall be forfeited if the communication is presented to the recipient and the recipient rejects the communication, dissolving the bond when the recipient accepts the communication, and causing the money associated with the bond to be forfeited when the recipient rejects the communication.

While the bonded approach has many advantages over prior art methods such as filtering, and the use of blocked senders lists, it may impose an undesirably large and unfair burden on legitimate e-mailers who send large numbers of e-mails to those with whom they have had previous contact or a business relationship. Also, despite safeguards in a bonded communication system, it is still possible for some recipients to abuse the system by unfairly rejecting communications from those who had a good faith reason to believe that their communications would be accepted.

What is therefore needed, are a system and method that discourage unwanted electronic communication by having the deterrent effect of satisfaction bonds, while allowing the flexibility to waive satisfaction bond requirements to reduce senders' liabilities when past conduct or present conditions indicate that communications are likely to be accepted during the normal course.

### SUMMARY OF THE INVENTION

In view of the aforementioned problems and deficiencies of the prior art, the present invention provides a method of regulating electronic communications. The method at least includes receiving an electronic communication from a sender for an intended recipient, determining whether the electronic communication is accompanied by a sufficient satisfaction bond, forwarding the electronic communication to the intended recipient when the electronic communication is accompanied by a sufficient satisfaction bond, determining whether a sufficient trust relationship exists between the sender and the intended recipient when the electronic communication is not accompanied by a sufficient satisfaction bond, and forwarding or refraining from forwarding the electronic communication to the intended recipient depending on whether a sufficient trust relationship exists between the sender and the intended recipient.

The present invention also provides a system for regulating electronic communications. The system at least includes:
at least one electronic communication sender;
at least one electronic communication recipient;
a third party intermediary; and
a satisfaction bond generator adapted to allow an electronic communication sender to acquire a satisfaction bond to be coupled with an electronic communication, the bond adapted to be forfeited if a recipient of the electronic communication to which the bond is coupled rejects the electronic communication;
wherein the third party intermediary at least includes:
   a communication receiver adapted to receive an electronic communication from a sender for an intended recipient;
   a bond legitimacy verifier adapted to, prior to receipt of the electronic communication by the intended recipient, verifying the legitimacy of the bond;
   a communication transmitter adapted to forward the electronic communication to the intended recipient when the electronic communication is accompanied by a sufficient satisfaction bond; and
   a trust relationship verifier adapted to determine whether a sufficient trust relationship exists between the sender and the intended recipient when the electronic communication is not accompanied by a sufficient satisfaction bond;
   wherein the communication transmitter is further adapted to forward or refraining from forwarding the electronic communication to the intended recipient depending on whether a sufficient trust relationship exists between the sender and the intended recipient.

The present invention further provides a method of regulating electronic communications that at least includes receiving an electronic communication from a sender for an intended recipient, determining whether a sufficient trust relationship exists between the sender and the intended recipient, forwarding the electronic communication to the intended recipient when a sufficient trust relationship exists between the sender and the intended recipient, subjecting the electronic communication to at least a further test to determine whether the electronic communication is to be forwarded to the intended recipient when a sufficient trust relationship does not exists between the sender and the intended recipient, and forwarding or refraining from forwarding the electronic communication to the intended recipient depending on the result of the further test.

### BRIEF DESCRIPTION OF THE DRAWING FIGURES

Features and advantages of the present invention will become apparent to those skilled in the art from the description below, with reference to the following exemplary drawing figures, in which:

FIG. 1 is a flowchart of the general present-inventive method of regulating communications between communication senders and communication recipients, a determination of the existence of a trust relationship between senders and recipients eliminates or modifies the requirement for satisfaction bonds;

FIG. 2 is a flowchart of the present-inventive methods for deriving the existence of a trust relationship for the case where a current intended recipient has previously transmitted an e-mail message to a current sender, and for the case where there was previous personal contact between a current intended recipient and a current sender (or its agent);

FIG. 3 is a flowchart of the present-inventive methods for deriving the existence of a trust relationship for the case where a current intended recipient has previously visited a web site under the dominion of a current sender, and for the case where a current intended recipient has previously transmitted an e-mail message to a current sender, with the current sender having transmitted a return e-mail with at least a partially matching subject line;

FIG. 4 is a schematic block diagram of a communication system capable of handling communications according to the present invention; and

FIG. 5 is a more detailed version of the inventive functions of an Internet Service Provider functioning in accordance with the present invention.

### DESCRIPTION OF THE PREFERRED EMBODIMENTS

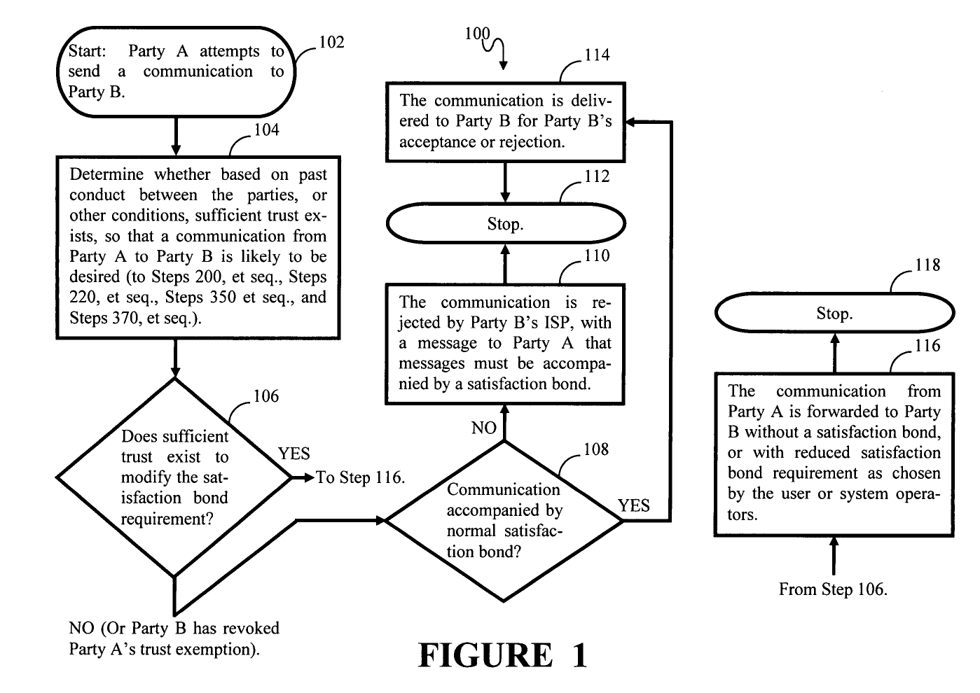

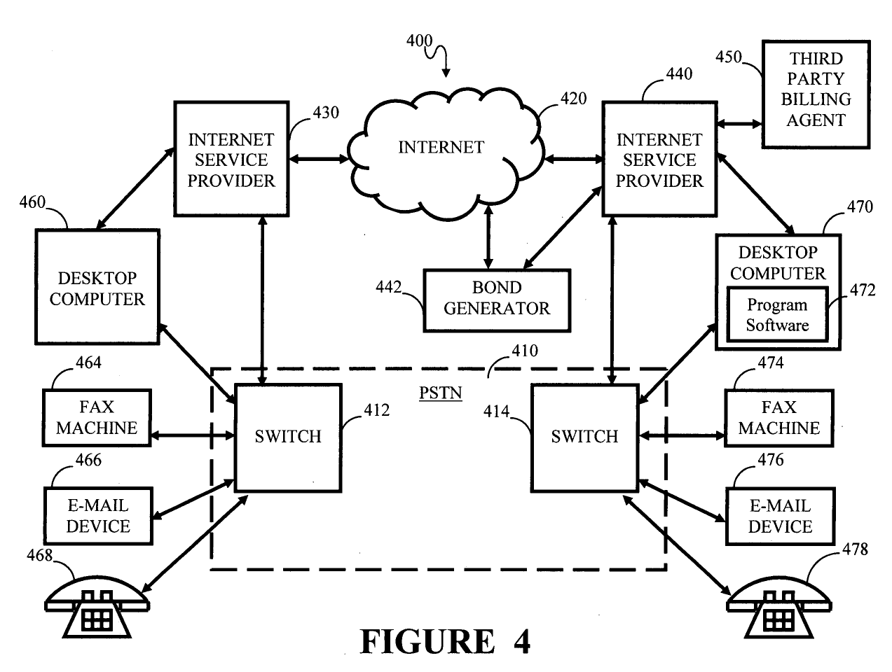

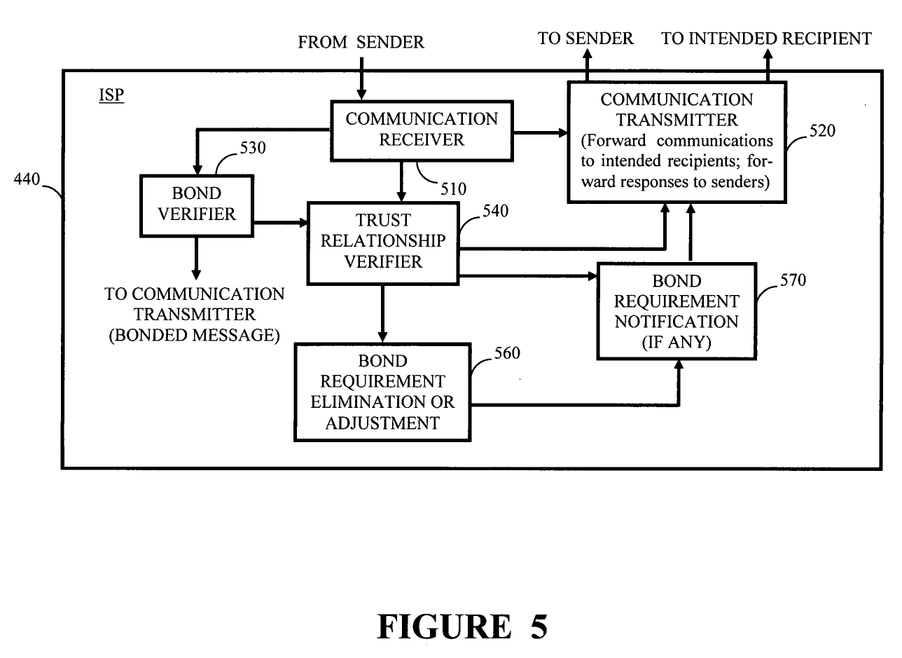

The present-inventive methods for regulating electronic communication are illustrated in FIGS. 1, 2 and 3. The details of a system capable of implementing the present-inventive methods are illustrated in FIGS. 4 and 5.

In the present-inventive methods and system, electronic communications are generally required to be accompanied by a satisfaction bond, as is detailed in the aforementioned U.S. Pat. No. 6,697,462. However, in the preferred embodiment of the present invention, the requirement of a satisfaction bond accompanying the communication is waived where a sufficient trust relationship is deemed to exist between the communication sender and the intended communication recipient.

An adequate trust relationship between two communication parties may be defined as the result of previous conduct or interaction between the parties, or a current condition, that makes it likely that a communication in question will in fact be accepted or deemed welcome by the communication recipient.

In an alternate embodiment, the satisfaction bond is not waived entirely, but the amount of the bond is reduced to a lower amount.

A general schematic block diagram of the present-inventive communication regulation system 400 is shown in FIG. 4. In the system 400, users can both send and receive a variety of electronic communications from a variety of sources, such as from computers (460, 470), facsimile machines (464, 474), special purpose hardware like electronic mail (e-mail) devices, or EMDs (466, 476), and conventional telephones (468, 478). Those skilled in the art to which the invention pertains will appreciate that other devices and other forms of communication can be regulated by the system without departing from the scope of the present invention. Further examples of these communications include “pop-up” menus and third party content messages received while a user is logged on to the Internet. Also, the devices can be connected to the system by both wired and wireless means.

In the preferred embodiment, the system 400 includes a Public Switched Telephone Network (PSTN) 410 for processing telephonic communications emanating from within and without the network. The details of a functioning PSTN are well known to those skilled in the art, and will thus not be repeated here, except to symbolically show telephonic switches 412 and 414. The present invention functions whether the communication is contained entirely within the PSTN, or whether there is extra-network handling. In an alternate embodiment, the connection to the PSTN may be bypassed entirely in favor of a cable modem connection, for communication between the ISP and the desktop computer.

Such extra-network handling includes communications which are transmitted and received through a wide area network (WAN) 420 such as the Internet. Connection to the Internet 420 is by way of one or more Internet Service Providers (ISPs) such as the ones 430 and 440.

A third party billing agent 450 handles financial transactions relating to credit cards and the like.

Users subscribing to the present inventive system and communication regulation service will have program software 472 installed in their computers for receipt of computer communications. Where the user receives a communication without a computer, the program software can be installed as part of the switches 412, 414, and/or as part of an Intelligent Network.

It is also the case that the present invention is applicable to message senders and recipients who are not subscribers to a particular system. A bond seller or bond generating entity 442 will either be contacted by a sender prior to attempting to send a message, or will be contacted after a recipient is informed that a bond is needed to send a particular message to an intended recipient.

The methods associated with the present invention, as described below, can be carried out by one or more communication servers under the control of the system ISPs, with each ISP having a separate server, or one or more centralized system servers.

FIG. 5 details the functional elements of an ISP 440 according to the present invention, although those skilled in the pertinent art to which the invention pertains will appreciate that these functions can be implemented elsewhere in the system.

A communication receiver 510 symbolically represents the function of receiving communications, including those intended to be forwarded to an intended recipient who is one of the ISP's subscribers. A communication transmitter 520 symbolically represents the function of transmitting communications, including forwarding communications to an intended recipient, feedback messages to a communication sender, and others.

The ISP checks incoming messages for an acceptable accompanying satisfaction bond via a bond verifier 530. If the messages are accompanied by appropriate satisfaction bonds, they are forwarded via the communication transmitter 520 to the intended recipient. Upon receipt, the intended recipient may either accept or reject the message. An acceptance has no further consequence to the sender. A rejection, however, causes the satisfaction bond res to be forfeited, as described in the aforementioned U.S. Pat. No. 6,697,462.

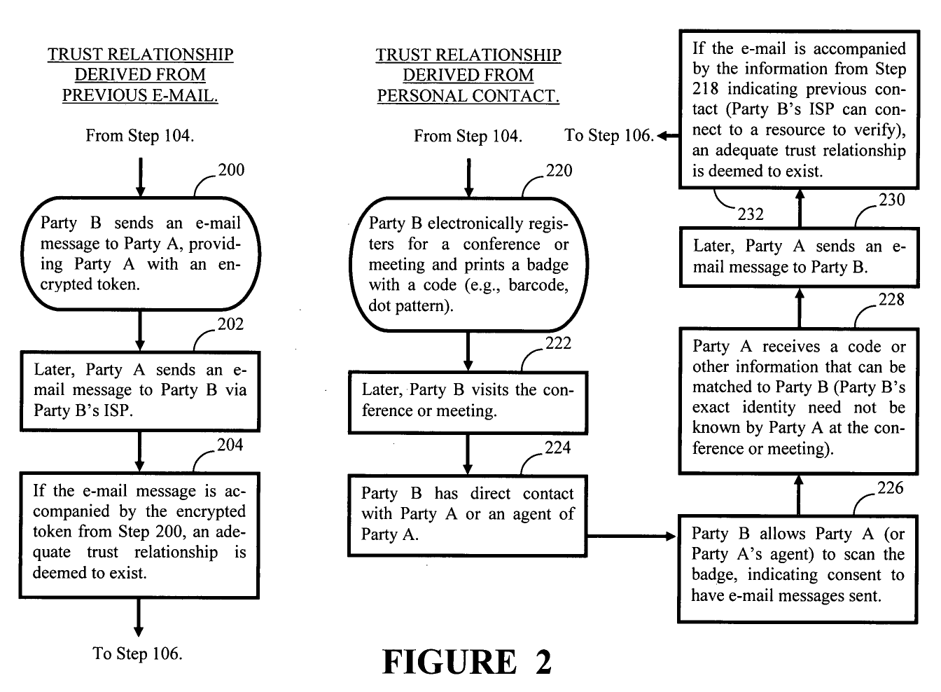

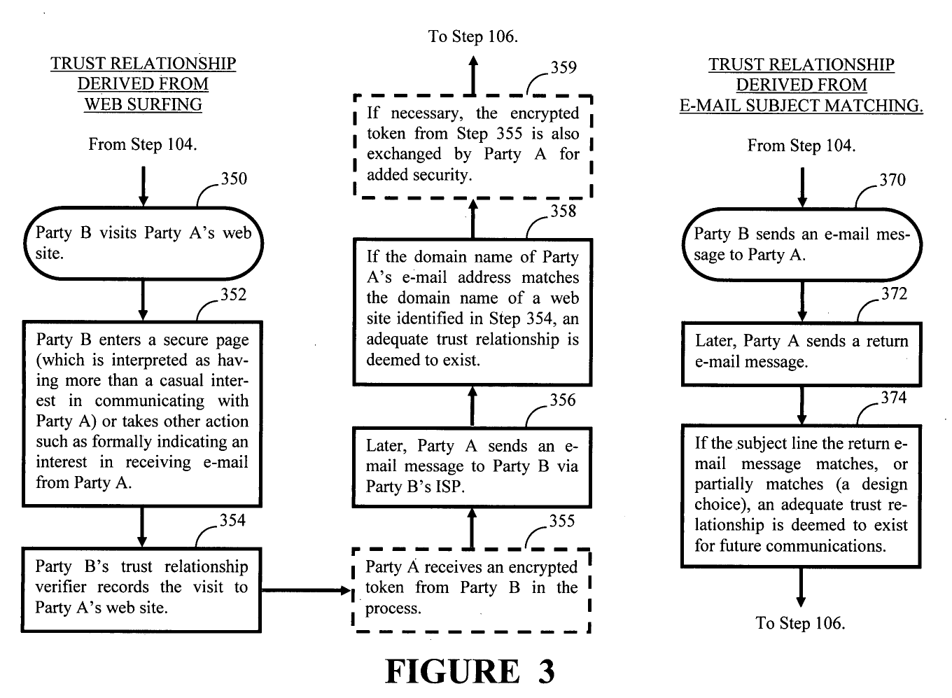

When a satisfaction bond does not accompany an incoming message, a trust relationship verifier determines whether a sufficient trust relationship exists between the communication parties. The trust relationship verification steps are illustrated in FIGS. 2 and 3. If an adequate trust relationship does not exist with respect to an unbonded message, the message is not forwarded to the intended recipient. Rather, the sender is notified via a bond requirement notifier 570 that a satisfaction bond is required before the message will be delivered to the intended recipient. Alternatively, lack of a sufficient trust relationship can cause the message to be filtered by conventional filtering means.

Even where an adequate trust relationship is deemed to exist, system subscribers have the option to cancel trust relationship conditions. Thus, the trust relationship verifier may also cause the message sender to be notified that a satisfaction bond is now required, where none had previously been required. Alternate embodiments allow the trust relationship to automatically lapse after the passage of a predetermined amount of time, or the transmission of a predetermined threshold number of messages.

When an adequate trust relationship is deemed to exist between the communication parties, the satisfaction bond requirement is waived in the preferred embodiment, leading to the message being forwarded to the intended recipient without further action on the part of the ISP. In an alternate embodiment, element 560, rather than eliminating the bond requirement, lowers the bond amount to a predetermined level.

The general algorithm 100 for regulating electronic communication according to the present invention is in FIG. 1. The algorithm starts when a message sender (Party A) sends a message to a particular recipient (Party B) in Step 102. In Step 104 the algorithm determines whether a sufficient trust relationship exists to bypass the normal satisfaction bond requirement. This step requires the execution of a number of separate steps illustrated in FIGS. 2 and 3. An alternate approach is to test the message for bond accompaniment first, and then to test for a trust relationship only if the bond requirement test fails.

If a sufficient trust relationship is deemed to exist between the communication parties, the communication is forwarded to the intended recipient without a satisfaction bond requirement, or with the requirement of a reduced satisfaction bond at the system operator's behest (Steps 106 and 116). In other words, the communication need not be accompanied by a satisfaction bond.

If however, a sufficient trust relationship does not exist between the communication parties, or the intended recipient has revoked the trust relationship, then the satisfaction bond requirement test is performed (Steps 106 and 108). If the appropriate satisfaction bond accompanies the communication, the communication is transmitted to the Party B for his/her acceptance or rejection, followed by the end of the algorithm (Steps 114 and 112). If an appropriate satisfaction bond does not accompany the communication, it is rejected by Party B's ISP (Step 110).

The present invention is directed to providing an exception to a requirement of satisfaction bonds where a sufficient relationship of trust is deemed to exist between the communication parties. Many approaches can be used to determine whether the relationship of trust exists, and the examples illustrated in this letters patent are not meant to be exhaustive.

A simple approach is that of the algorithm consisting of Steps 200-204 in FIG. 2. In this approach, a trust relationship is derived or deemed to exist when Party B has previously sent an e-mail message to Party A. More particularly, the algorithm begins with Party B sending and e-mail message to Party A, which includes an encrypted token associated with Party B (Step 200).

At some later time (Step 202), Party A sends an e-mail message to Party B (through Party B's ISP). If the e-mail message is accompanied by the appropriate encrypted token (from Step 200), Party A is deemed to have demonstrated that Party B has initiated communication, and that a trust relationship exists (Step 204). Recall that a sufficient relationship of trust is deemed to exist between the communication parties when previous conduct or conditions exist that make it likely that the intended recipient will desire to receive communications from the sender. After Step 204, the method returns to Step 106 of the algorithm 100.

Another approach is to derive the presence of a trust relationship from the previous personal contact between the communication parties. This is the approach in Steps 220-232 in FIG. 2. To begin (Step 220), Party B registers to attend a conference or meeting through electronic means such as the Internet. Following the registration, Party B prints a badge or other indicia indicating that he/she is registered for the conference/meeting.

Later, Party B attends the conference/meeting and has direct contact with Party A or Party A's agent (Steps 222 and 224). Party B can indicate that he/she is willing to receive future communications by allowing Party A to scan the badge and store the code or other information printed thereon (Step 226). The information received from the badge can later be matched to Party B and his/her implied consent to receive communications from Party A is presumed (Step 228).

If Party A sends a message to Party B and it is accompanied by the information scanned at the conference/meeting, indicating that Party B desires to receive communications from Party A, an adequate trust relationship is deemed to exist (Steps 230 and 232). It should be noted that it is not necessary for Party A to know Party B's complete identity. For example, Party A might send a large number of e-mail messages to a target group of individuals. Along with this batch of e-mail messages, could be a file listing information associated with the conference/meeting attendees. If an intended recipient in question has attended the conference/meeting, a specific trust relationship is deemed to exist for the sender and the particular recipient. After Step 232, the method returns to Step 106 of the algorithm 100.

A trust relationship can also be derived from Party B “surfing” web sites controlled by Party A. In the preferred embodiment however, something more than merely visiting a web site is required to ensure that the interest in receiving future communications is genuine. This approach is illustrated in Steps 350-359 in FIG. 3.

The first step is a visit (via computer) to Party A's web site (Step 350). Some other overt action by Party B is performed indicating a desire to receive communications. This can be entering a secure web page or expressly indicating an interest in receiving future e-mail (Step 352). Party B's trust relationship verifier records the visit to the website in Step 354. In an alternate embodiment, Party A also receives an encrypted token from Party B in Step 355 for an added level of verification. The latter step, however, is not required for the algorithm and approach in Steps 350 et seq. to function.

Later, when Party A sends a message to Party B, an adequate trust relationship is deemed to exist if the domain name of Party A's address matches the domain name of a web site which Party B has visited and further entered a secured page, etc. (Steps 356 and 358).

In the alternate approach where Step 355 is implemented, an additional step (359) is also performed. In Step 359 Party A must also exchange the encrypted token received in Step 355 to demonstrate with greater certainty that a trust relationship exists between the parties. After Step 358 (or Step 359 in the alternate embodiment), the method returns to Step 106 of the algorithm 100.

Yet a further approach to deriving a trust relationship is illustrated in Steps 370-374 of FIG. 3. This is a variation of the approach in Steps 200-204. In the beginning step (370) Party B sends a conventional e-mail message to Party A. Later, Party A sends a return e-mail message (372). The existence vel non of a trust relationship is determined by comparing the subject or title lines of the two e-mail messages (Step 374).

In one embodiment, a trust relationship is deemed to exist when the subject lines of the two e-mails in question are identical, save de minimis differences (e.g., prefixes and suffixes such as “RE,” “FW,” etc.). A return e-mail with a matching subject/title line can be interpreted as an indication that the intended recipient has previously initiated communication, and is therefore less likely to reject communications from the sender. In another embodiment, only a string of characters must match in the two messages for a match to exist. This allows the system to ignore abbreviations and the like that the sender may have inserted at the beginning or end of the return e-mail message.

The subject lines of both incoming and outgoing e-mail, along with the identities of the destination parties can be monitored by a subscriber's ISP in the present-inventive system.

Variations and modifications of the present invention are possible, given the above description. However, all variations and modifications which are obvious to those skilled in the art to which the present invention pertains are considered to be within the scope of the protection granted by this Letters Patent. For example, the approach of the present invention, while described primarily with regard to e-mail, applies to all types of electronic communication, including, inter alia, web pop-ups, telephone calls, and facsimile transmissions.

What is claimed is:

1. A method of regulating electronic communications comprising:
a) receiving an electronic communication from a sender for an intended recipient;
b) determining whether said electronic communication is accompanied by a sufficient satisfaction bond;
c) forwarding said electronic communication to said intended recipient when said electronic communication is accompanied by a sufficient satisfaction bond;
d) determining whether a sufficient trust relationship exists between said sender and said intended recipient when said electronic communication is not accompanied by a sufficient satisfaction bond; and
e) forwarding or refraining from forwarding said electronic communication to said intended recipient depending on whether a sufficient trust relationship exists between said sender and said intended recipient.

2. A system for regulating electronic communications comprising:
at least one electronic communication sender;
at least one electronic communication recipient;
a third party intermediary; and
a satisfaction bond generator adapted to allow an electronic communication sender to acquire a satisfaction bond to be coupled with an electronic communication, said bond adapted to be forfeited if a recipient of the electronic communication to which the bond is coupled rejects the electronic communication;
wherein said third party intermediary comprises:
a communication receiver adapted to receive an electronic communication from a sender for an intended recipient;
a bond legitimacy verifier adapted to, prior to receipt of said electronic communication by the intended recipient, verifying the legitimacy of said bond;
a communication transmitter adapted to forward said electronic communication to said intended recipient when said electronic communication is accompanied by a sufficient satisfaction bond; and
a trust relationship verifier adapted to determine whether a sufficient trust relationship exists between said sender and said intended recipient when said electronic communication is not accompanied by a sufficient satisfaction bond;
wherein said communication transmitter is further adapted to forward or refraining from forwarding said electronic communication to said intended recipient depending on whether a sufficient trust relationship exists between said sender and said intended recipient.

3. A method of regulating electronic communications comprising:
a) receiving an electronic communication from a sender for an intended recipient;
b) determining whether a sufficient trust relationship exists between said sender and said intended recipient;
c) forwarding said electronic communication to said intended recipient when a sufficient trust relationship exists between said sender and said intended recipient;
d) subjecting said electronic communication to at least a further test to determine whether said electronic communication is to be forwarded to said intended recipient when a sufficient trust relationship does not exists between said sender and said intended recipient; and
e) forwarding or refraining from forwarding said electronic communication to said intended recipient depending on the result of said further test.

4. The method of claim 1, wherein said electronic communications comprise electronic mail (“e-mail”) messages.

5. The method of claim 1, wherein said electronic communications comprise web pop-up messages.

6. The method of claim 1, wherein said electronic communications comprise facsimile transmissions.

7. The method of claim 1, wherein said electronic communications comprise telephone calls.

8. The method of claim 1, wherein element d) comprises determining that a sufficient trust relationship exists when said intended recipient has previously sent an electronic communication to said sender.

9. The method of claim 1, wherein element d) comprises determining that a sufficient trust relationship exists when said intended recipient has previously sent an electronic communication to said sender, from which an encrypted token is provided to said sender, and verifying that an electronic communication received in element a) is accompanied by an appropriate encrypted token.

10. The method of claim 1, wherein element d) comprises determining that a sufficient trust relationship exists when said intended recipient has previously connected via a computer to a web site under the dominion of said sender.

11. The method of claim 1, wherein element d) comprises determining that a sufficient trust relationship exists when said intended recipient has previously connected via a computer to a web site under the dominion of said sender, and said intended recipient has undertaken action construed as indicating that future communications from a sender having dominion over said web site will be accepted.

12. The method of claim 1, wherein element d) comprises determining that a sufficient trust relationship exists when said intended recipient has previously connected via a computer to a web site under the dominion of said sender, and said intended recipient has entered a secure page associated with said web site.

13. The method of claim 1, wherein element d) comprises determining that a sufficient trust relationship exists when said intended recipient has previously had personal contact with said sender or an agent of said sender, and provided said sender with personal enabling information during said personal contact, and verifying that an electronic communication received in element a) is accompanied by appropriate personal enabling information.

14. The method of claim 1, wherein element d) comprises determining that a sufficient trust relationship exists when said intended recipient has previously sent an e-mail message to said sender, and that a sender has sent a return e-mail message to said intended recipient having a title header at least partially matching the title header of the previously sent e-mail message from said recipient to said sender.

15. The method of claim 1, wherein element d) comprises determining that a sufficient trust relationship exists when an electronic communication emanates from a domain associated with a web site under the dominion of a sender to which an intended recipient has previously connected via a computer.

16. The method of claim 1, wherein a trust relationship is revocable on the demand of a recipient.

17. The method of claim 1, wherein a trust relationship automatically expires with the passage of a predetermined amount of time.

18. The method of claim 1, wherein a trust relationship automatically expires upon exceeding a predetermined number of communications from a sender to an intended recipient.

19. The method of claim 1, wherein element d) further comprises filtering sender's communications using a list related to senders who have established a sufficient trust relationship.

20. The method of claim 3, further comprising:
disabling elements d) and e); and
wherein element c) further comprises, prior to forwarding said electronic communication; determining whether a receive communication is accompanied by a sufficient satisfaction bond, wherein the presence of a sufficient trust relationship changes the level of the satisfaction bond to a predetermined lower amount.
